(19) United States
(12) Patent Application Publication
(10) Pub. No.: US 2013/0019520 A1
(43) Pub. Date: Jan. 24, 2013

(54) Methods of Making Fatty Acids and Fatty Acid Alkyl Esters

(71) Applicants: Jason K. Sello, Providence, RI (US); Aaron M. Socha, Providence, RI (US)

(72) Inventors: Jason K. Sello, Providence, RI (US); Aaron M. Socha, Providence, RI (US)

(73) Assignee: Brown University, Providence, RI (US)

(21) Appl. No.: 13/362,008

(22) Filed: Jan. 31, 2012

Related U.S. Application Data
(60) Provisional application No. 61/438,776, filed on Feb. 2, 2011.

(51) Int. Cl. C11C 3/10; C11C 3/00; C10L 1/19; C11C 1/04

(52) U.S. Cl. 44/307; 554/167; 554/163; 44/388

(57) ABSTRACT

The present invention is directed to methods of making fatty acid esters from glycerides and free fatty acids.

### RELATED APPLICATION DATA

This application claims priority to U.S. Provisional Patent Application No. 61/438,776, filed on Feb. 2, 2011 and is hereby incorporated herein by reference in its entirety for all purposes.

### FIELD

The present disclosure relates to the use of catalysts to convert fatty acids to their corresponding alkyl esters. The alkyl esters can be used as biodiesel. The present disclosure also relates to converting triacylglycerols to free fatty acids.

### BACKGROUND

Both acid-catalyzed esterification of free fatty acids and alkali-catalyzed transesterification of triacylglycerols are used to make biodiesel, which commonly includes the alkyl esters of fatty acids. The most common biodiesel precursors are triacylglycerols comprising virgin oils directly isolated from plants such as soy, canola, and palm. Typically, the transesterification of triacylglycerols into biodiesel is performed in methanol using catalytic quantities of either potassium hydroxide or sodium hydroxide.

A lower cost and more readily abundant source of biodiesel precursors is the waste vegetable oil resulting from food preparation. The cost and positive environmental impact of recycling waste vegetable oil is a significant motivation for its use as a feedstock for biodiesel. In spite of the advantages of waste vegetable oil in terms of cost as a feed stock and the positive environmental impact due to recycling, the chemical heterogeneity of waste vegetable oil presents challenges for biodiesel production. The major constituents of waste vegetable oil are triacyglycerols, free fatty acids, and water. The free fatty acids, which can be the major constituent of extensively used waste vegetable oil, yield soaps under alkaline reaction conditions that complicate downstream product isolation. Thus, the conversion of waste vegetable oil to biodiesel commonly includes a two-step process: acid-catalyzed esterification of the free fatty acids followed by the base-catalyzed transesterification of triacylglycerols. Because fatty acid esterification typically uses sulfuric acid, workup requires additional time and risk, and quickly leads to equipment corrosion.

Reagents commonly used in organic chemistry are promising alternatives to current industrial methods for biodiesel production. There are numerous solid acid catalyst alternatives to sulfuric acid (Meleo, Green Chem., 2009, 1185-1308), including zeolites (Brito, Energy Fuels, 2007, 21, 3280-3283), Nafion (Lopez, J. Catal. 2007, 245, 381-391), Amberlyst (Hara, ChemSusChem 2009, 2, 129-135), heteropoly acids (Zhang, Bioresour. Technol., 2010, 101, 931-936), and sulfonated sugars (Toda, Nature, 2005, 438, 178). Among the best candidates are the heteropoly acids, which have been shown to convert both free fatty acids and triacylycerols to methyl esters. See Zhang, Bioresour. Technol., 2010, 101, 931-936; Caeta, Catal. Commun., 2008, 9, 1996-1999; and Cardoso, J. Am. Oil Chem. Soc., 2008, 85, 555-560. Unfortunately, these solid catalysts are often expensive and rarely outperform sulfuric acid.

AlCl₃ was shown to convert canola oil to biodiesel, but the reaction required 18 hours at 110° C. and THF as a co-solvent. See Soriano, Fuel, 2009, 88, 560-565. Similarly, the acetates of Cd, Pb, and Zn were reported to convert both soybean oil and palmitic acid to biodiesel, and this reaction was accelerated significantly in subcritical methanol. See Hou, Kor. J. Chem. Eng. 2007, 24, 311-313. However, the toxicity and air-sensitivity of these Lewis acid catalysts precludes their application on an industrial scale.

Scandium triflate has been reported to catalyze the transesterification of low molecular weight esters. See Synlett., 2007, 3, 491-493. Potassium hydroxide-promoted transesterification of triacylglycerols into biodiesel is reportedly more efficient in a microwave reactor. See Energy Fuels, 2006, 20, 2281-2283 and Energy Fuels, 2007, 21, 1777-1781. Biodiesel production would greatly benefit from the availability of stable catalysts that can efficiently convert both fatty acids and triacylglycerols into alkyl esters under mild and environmentally benign conditions and with sufficient recovery of the catalysts.

It is therefore an object of the present disclosure to convert fatty acids and/or triacylglycerides into alkyl esters. It is a further object of the present disclosure to convert a mixture of free fatty acids and triacylglycerides, such as is found in waste vegetable oil, into alkyl esters. It is a still further object of the present disclosure to convert a mixture of free fatty acids and triacylglycerols into alkyl esters using Lewis acid catalysts and microwave heating.

These and other objects, features, and advantages described in the present disclosure will be apparent to those skilled in the art from the following disclosure and description of exemplary embodiments.

### SUMMARY

Embodiments of the present disclosure are directed to methods of converting components of vegetable oil, such as free fatty acids and triacylglycerols, into their corresponding alkyl esters. The alkyl esters have various uses including use as a biodiesel fuel, use as a component in cosmetics, and lubricants and any other application where alkyl esters of free fatty acids or glycerides, such as triacylglycerols, diglycerides and monoglycerides, find utility.

According to certain aspects of the present disclosure, a method of making biodiesel is provided where a Lewis acid in a catalytically effective amount, an alcohol, and vegetable oil including acylglycerides and free fatty acids are combined and heated using microwaves, such as provided by a microwave reactor to produce alkyl esters from the acylglycerides and the free fatty acids.

Aspects of the present disclosure are also directed to methods of hydrolyzing one or more triacylglycerols to free fatty acids when heated using microwaves in the presence of water and a strong acid catalyst. An exemplary aspect includes dissolving a triacylglycerol, a diglyceride or a monoglyceride in water and an acid, such as acetic acid and heating in a microwave reactor for a period of time in the presence of a strong acid catalyst to produce free fatty acids.

### BRIEF DESCRIPTION OF THE DRAWINGS

FIG. 1 is a graph showing yields of palmitic acid esterification from sequential catalyst recycling experiments.

### DETAILED DESCRIPTION OF CERTAIN EXEMPLARY EMBODIMENTS

Embodiments of the present disclosure are directed to the use of Lewis acids as catalysts to convert triacylglycerols to alkyl esters when heated using microwaves. Embodiments of the present disclosure are further directed to the use of Lewis acids as catalysts to convert free fatty acids to alkyl esters when heated using microwaves. Further embodiments of the present disclosure are directed to the use of Lewis acids as catalysts to convert a mixture of triacylglycerides and free fatty acids to their corresponding alkyl esters when heated using microwaves. Still further embodiments are directed to the use of inorganic acids as catalysts to convert triacylglycerols to free fatty acids.

In accordance with certain aspects of the present disclosure, a triacylglycerol, also referred to as a triglyceride, includes a compound represented by formula I below.

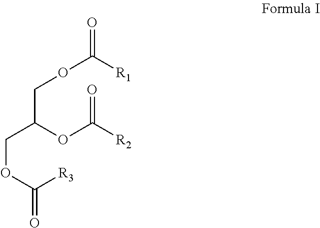

According to certain aspects, R₁, R₂, or R₃ is an alkyl group or carbon chain having between about 3 carbon atoms and about 27 carbon atoms. Additional embodiments include R₁, R₂, or R₃ being a carbon chain having fewer than 6 carbon atoms, between about 6 carbon atoms and about 12 carbon atoms, more than about 12 carbon atoms, between about 12 carbon atoms and about 26 carbon atoms, and more than about 22 carbon atoms, or any value or range in between whether overlapping or not. In certain embodiments, the alkyl group is a straight chain or a branched chain. In certain other embodiments, the alkyl group is saturated or unsaturated. For example, an exemplary degree of unsaturation is between about 1 to about 4 degrees of unsaturation. The carbon chain can include one or more double bonds or one or more triple bonds. Where the carbon chain is unsaturated with one or more double bonds, the double bond can occur in either the cis or trans configuration. In certain other embodiments, the carbon chain is substituted or unsubstituted. Substituted fatty acids include fatty acids substituted with C₁ to C₄ alkyl groups, such as methyl, ethyl, propyl and butyl.

According to one aspect, R₁, R₂, or R₃ are the same or different. According to an additional aspect, R₁, R₂, and R₃ have the same number of carbon atoms. R₁, R₂, or R₃ within the scope of the present disclose, when including the carbonyl group to which they are attached, will be recognized by those of skill in the art as an acyl group, or the component of a free fatty acid that has been joined to the hydroxyl group of glycerol to form an ester. Accordingly, the general structure of formula I can be considered a triacylglycerol or a triglyceride. However, diglycerides (two acyl groups) are also contemplated by the present disclosure where one acyl group in formula I is substituted with a hydrogen in formula I to form a hydroxyl group. Likewise, monoglycerides (one acyl group) are also contemplated by the present disclosure where two acyl groups in formula I are each substituted with a hydrogen in formula I to form two hydroxyl groups. According to this aspect, monoglycerides or diglycerides can be converted to alkyl esters using the methods of the present disclosure. Accordingly, one of skill in the art will readily understand the terms triacylglycerol, triglyceride, diglyceride and monoglyceride to include the many saturated and unsaturated triacylglycerols, triglycerides, diglycerides and monoglycerides identified in readily available literature sources and those found in virgin plant oils such as glyceryl trioleate, glyceryl trilinoleate, glyceryl trimyristate and glyceryl tripalmitate. Such triacylglycerols, triglycerides, diglycerides and monoglycerides include those that are naturally occurring, i.e. found in nature or non-naturally occurring, i.e. not found in nature. The source of such triacylglycerols, triglycerides, diglycerides and monoglycerides can be the natural product itself or organic synthesis, i.e. a synthetic molecule.

According to an additional aspect, a free fatty acid includes a compound represented by formula II below.

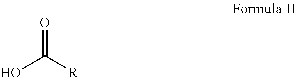

According to certain aspects, R is an alkyl group or carbon chain having between about 3 carbon atoms and about 27 carbon atoms. Additional embodiments include R being a carbon chain having fewer than 6 carbon atoms, between about 6 carbon atoms and about 12 carbon atoms, more than about 12 carbon atoms, between about 12 carbon atoms and about 26 carbon atoms, and more than about 22 carbon atoms, or any value or range in between whether overlapping or not. In certain embodiments, the alkyl group is a straight chain or a branched chain. In certain other embodiments, the alkyl group is saturated or unsaturated. For example, an exemplary degree of unsaturation is between about 1 to about 4 degrees of unsaturation. The carbon chain can include one or more double bonds or one or more triple bonds. Where the carbon chain is unsaturated with one or more double bonds, the double bond can occur in either the cis or trans configuration. In certain other embodiments, the carbon chain is substituted or unsubstituted. Substituted fatty acids include fatty acids substituted with C₁ to C₄ alkyl groups, such as methyl, ethyl, propyl and butyl.

Aspects of the present disclosure contemplate a mixture of one or more compounds of formula I with one or more compounds of formula II. Such mixtures can be made by selecting one or more compounds of formula I and one or more compounds of formula II and blending them together. Alternatively, such mixtures can also be found as naturally occurring mixtures.

Vegetable oils also represent compounds of the present disclosure that include triglycerides, diglycerides, monoglycerides and free fatty acids useful for making biodiesel fuels. Such vegetable oils include castor oil, coconut oil, corn oil, cottonseed oil, false flax oil, hemp oil, jatropha oil, mustard oil, olive oil, palm oil, peanut oil, pennycress oil, radish oil, rapeseed oil, ramtil oil, rice bran oil, safflower oil, salicornia oil, sesame oil, soybean oil, sunflower oil, tigernut oil, tung oil and the like. It is to be understood that any particular vegetable oil may include a mixture of different triglycerides, diglycerides, monoglycerides and/or free fatty acids of various chain lengths.

Also contemplated by the present disclosure is a mixture of vegetable oils. Vegetable oils or mixtures of vegetable oils can include a mixture of one or more of triglycerides, diglycerides, monoglycerides and free fatty acids. The vegetable oil can be unused and may be referred to as straight vegetable oil or pure plant oil. Alternatively, vegetable oil that has been used in cooking processes may be referred to as waste vegetable oil. Such waste vegetable oil can include one or more of triglycerides, diglycerides, monoglycerides and/or free fatty acids.

One of skill in the art will understand that free fatty acids can be identified by the number of carbon atoms in the carbon chain R and including the carbon atom included in the carbonyl group. For example, where R is a straight carbon chain of 11 carbon atoms and including the carbonyl carbon for a total of 12 carbon atoms, the resulting free fatty acid is lauric acid. Accordingly, one of skill in the art will readily understand the term free fatty acid to include the many saturated and unsaturated free fatty acids identified in readily available literature sources. Such free fatty acids include those that are naturally occurring, i.e. found in nature or non-naturally occurring, i.e. not found in nature. The source of such free fatty acids can be the natural product itself or organic synthesis.

For example the following free fatty acids contemplated within the scope of the present disclosure include acetic acid, propionic acid, isobutyric acid (2-methylpropanoic acid), butyric acid, isovaleric acid (3-methylbutanoic acid), valeric acid (pentanoic acid), caproic acid, (hexanoic acid), lauric acid, myristic acid, myristoleic acid, palmitic acid, palmitoleic acid, sapienic acid, stearic acid, oleic acid, linoleic acid, α-linolenic acid, arachidic acid, arachidonic acid, eicosapentaenoic acid, behenic acid, erucic acid, docosahexaenoic acid, lignoceric acid, cerotic acid, and the like. Likewise, the free fatty acids, whether the same or different, can be used to make triglycerides, diglycerides and monoglycerides insofar as a free fatty acid can react with a hydroxyl group of glycerol to form an ester and so the nomenclature of triglycerides, diglycerides and monoglycerides can be based on the nomenclature for the free fatty acid.

According to aspects of the present invention, one or more compounds of formula I, such as triacylglycerols, or one or more compounds of formula II, such as free fatty acids, or a mixture of one or more compounds of formula I with one or more compounds of formula II are processed in a manner to produce alkyl esters. For example, one or more compounds of formula I or one or more compounds of formula II or a mixture of one or more compounds of formula I with one or more compounds of formula II are heated using microwaves for a period of time in the presence of a Lewis acid catalyst and an alkanol. The one or more compounds of formula I are converted into fatty acid alkyl esters by transesterification. The one or more compounds of formula II are converted by esterification into fatty acid alkyl esters.

According to one aspect, one or more compounds of formula I or one or more compounds of formula II or a mixture of one or more compounds of formula I or one and more compounds of formula II are heated using a microwave reactor to a temperature between about 20° C. and about 200° C., about 30° C. and about 200° C., about 40° C. and about 200° C., about 50° C. and about 200° C., about 60° C. and about 200° C., about 70° C. and about 200° C., about 80° C. and about 200° C., about 90° C. and about 200° C., about 100° C. and about 200° C., between about 110° C. and about 190° C., between about 120° C. and about 180° C., between about 130° C. and about 170° C., between about 140° C. and about 170° C., and about 150° C. and any values or ranges in between whether overlapping or not. It is to be understood that the ends of ranges can be combined to create ranges, as well, with having to expressly provide all combinations of possible ranges herein. For example, an exemplary range includes between about 50° C. and about 150°. A suitable microwave apparatus for purposes of the present disclosure is described in Energy Fuels, 2006, 20, 2281-2283 and Energy Fuels, 2007, 21, 1777-1781 each hereby incorporated herein by reference in their entireties.

According to one aspect, one or more compounds of formula I one or more compounds of formula II or a mixture of one or more compounds of formula I one or more compounds of formula II are heated using a microwave reactor for a time period of between about 0.5 minutes and about 10 minutes, between about 1 minutes and about 5 minutes, for about 1 minute, for about 5 minutes, for about 40 minutes, between about 0.5 minutes and about 50 minutes, between about 1 minute and about 40 minutes, between about 10 minutes and about 40 minutes, between about 20 minutes and about 30 minutes, for about 20 minutes, for about 25 minutes, for about 30 minutes, and any value or range in between whether overlapping or not. It is to be understood that the ends of ranges can be combined to create ranges, as well, with having to expressly provide all combinations of possible ranges herein. For example, an exemplary range includes between about 20 minutes and about 50 minutes. For esterification, an exemplary reaction time and temperature is about 1 minute at about 150° C. For transesterification, an exemplary reaction time and temperature is about 40 minutes at about 150° C.

According to one aspect, the alcohol includes an alkyl alcohol having an alkyl group of from 1 to 5 carbon atoms, such as methyl, ethyl, propyl, isopropyl, butyl, sec-butyl, tert-butyl, pentyl, isopentyl any the like. Suitable alcohols include, methanol, ethanol, propanol, butanol and pentanol. The alcohol provides the alkyl part of the alkyl esters. Accordingly, methyl esters, ethyl esters, propyl esters, butyl esters, pentyl esters, and the like are contemplated by the present disclosure depending upon the particular use of the alkyl esters. For example, any alkyl ester useful as a biodiesel fuel, such as methyl esters, ethyl esters, or propyl esters or mixtures thereof, is contemplated by the present disclosure.

According to one aspect, a Lewis acid such as a Lewis acidic metal catalyst useful in the present method includes any species that accepts lone pair electrons. Exemplary Lewis acidic metal catalysts include scandium triflate, bismuth triflate, ytterbium triflate, BF₃, SiF₄, AlX₃ where X is a halogen and the like. The Lewis acidic metal catalysts of the present disclosure are present in the reaction in a catalytically effective amount and act as catalysts to promote the esterification of free fatty acids to alkyl esters or transesterification of triacylglycerols to alkyl esters. One or more Lewis acid catalysts can be used in the present disclosure to convert free fatty acids and/or triacylglycerols to their corresponding alkyl esters. A Lewis acid can be present in a particular reaction in an amount of about 1 mol %, between about 1 mol % to about 15 mol %, about 2 mol % to about 14 mol %, about 3 mol % to about 13 mol %, about 5 mol % to about 10 mol %, or about 10 mol % or any value or range in between whether overlapping or not. An exemplary amount for esterification is about 1 mol %. An exemplary amount for transesterification is about 10 mol %.

Fatty acid alkyl esters produced using the methods of the present disclosure are useful as biodiesel. Biodiesels are commonly understood to include carbon chain alkyl (methyl, ethyl, propyl etc.) esters where the carbon chain includes from about 3 carbon atoms to about 24 carbon atoms. Accordingly, aspects of the present disclosure are directed to a method for making biodiesel by converting one or more triacylglycerol compounds of formula I and one or more free fatty acid compounds of formula II whether alone or as a mixture to their corresponding alkyl esters using a Lewis acid catalyst as described above and an alcohol as described above while using microwave heating as described above. A particularly exemplary embodiment is a method that includes a reaction mixture of one or more triacylglycerol compounds of formula I and one or more free fatty acid compounds of formula II, an alcohol and a Lewis acid catalyst being heated using a microwave reactor to produce fatty acid methyl esters from the triacylglycerol compounds and the fatty acids in the mixture. Such a reaction is referred to as a one pot reaction because all of the reactants are included in a single reaction vessel.

According to an additional aspect, waste vegetable oil is the source of the mixture of one or more triacylglycerol compounds of formula I and one or more free fatty acid compounds of formula II. Waste vegetable oil can be sourced from restaurants and is generally processed to remove particulate matter and water using methods known to those of skill in the art, such as filtration through Celite to remove particulates and heating to remove water, before being converted into fatty acid alkyl esters for use as biodiesel.

Fatty acid alkyl esters produced using the methods of the present invention are also useful as emollients in cosmetic formulations and topical medicinal preparations where good absorption through skin is desired. Accordingly, aspects of the present disclosure are directed to a method for making cosmetic formulations by converting one or more triacylglycerol compounds of formula I and one or more free fatty acid compounds of formula II whether alone or as a mixture to their corresponding alkyl esters using a Lewis acid catalyst as described above and an alcohol as described above while using microwave heating as described above. The resulting fatty acid alkyl esters can be combined with cosmetic formulation ingredients known to those of skill in the art to produce a particular cosmetic formulation. Some ingredients of a basic cosmetic formulation include emulsifiers, surfactants, fatty chemicals, emollients and moisturizers, powders, fragrances, polymers, gums, colloids, hydrocolloids, humectants, quaternaries, silicones, thickeners, color additives and preservatives.

Aspects of the present disclosure are also directed to methods of hydrolyzing one or more compounds of formula I to free fatty acids when heated using microwaves in the presence of water and a strong acid catalyst. An exemplary aspect includes dissolving a compound of formula I, which may be a triacylglycerol, a diglyceride or a monoglyceride in water and an acid, such as acetic acid and heating in a microwave reactor for a period of time in the presence of a strong acid catalyst to produce free fatty acids. The source of the compound of formula I can be vegetable oils whether straight vegetable oil or waste vegetable oil.

According to one aspect, one or more compounds of formula I are heated in the presence of water, an organic acid such as formic acid, acetic acid, propionic acid and the like, and a strong acid catalyst using a microwave apparatus to a temperature between about 100° C. and about 200° C., between about 175° C. and about 200° C., between about 110° C. and about 190° C., between about 120° C. and about 180° C., between about 130° C. and about 170° C., between about 140° C. and about 170° C., and about 150° C. and any values or ranges in between whether overlapping or not. It is to be understood that the ends of ranges can be combined to create ranges, as well, with having to expressly provide all combinations of possible ranges herein. A suitable microwave apparatus for purposes of the present disclosure is described in Energy Fuels, 2006, 20, 2281-2283 and Energy Fuels, 2007, 21, 1777-1781 each hereby incorporated herein by reference in their entireties.

According to one aspect, one or more compounds of formula I are heated in the presence of water, an organic acid such as formic acid, acetic acid, propionic acid and the like and a strong acid catalyst using a microwave apparatus for a time period of between about 0.5 minutes and about 10 minutes, between about 1 minutes and about 5 minutes, for about 1 minute, for about 5 minutes, between about 0.5 minutes and about 50 minutes, between about 1 minute and about 40 minutes, between about 2 minutes and about 10 minutes, between about 10 minutes and about 40 minutes, between about 20 minutes and about 30 minutes, for about 20 minutes, for about 25 minutes, for about 30 minutes, and any value or range in between whether overlapping or not. It is to be understood that the ends of ranges can be combined to create ranges, as well, with having to expressly provide all combinations of possible ranges herein.

According to one aspect, the strong acid catalyst can include one or more strong inorganic acids in a catalytically effective amount. Exemplary strong acids include sulfuric acid, hydrochloric acid, triflic acid and the like. Exemplary solid acid catalysts include amberlyst 15, nafion, heteropolyacids, zeolites and the like. The strong acid is present in an amount between about 10 mol % and about 100 mol %, about 20 mol % and about 90 mol %, about 30 mol % and about 80 mol %, about 40 mol % and about 70 mol %, about 50 mol % and about 60 mol %, and any value or range in between whether overlapping or not. It is to be understood that the ends of ranges can be combined to create ranges, as well, with having to expressly provide all combinations of possible ranges herein.

It is to be understood that the embodiments of the present invention which have been described are merely illustrative of some of the applications of the principles of the present invention. Numerous modifications may be made by those skilled in the art based upon the teachings presented herein without departing from the true spirit and scope of the invention. The contents of all references, patents and published patent applications cited throughout this application are hereby incorporated by reference in their entirety for all purposes.

The following examples are set forth as being representative of the present invention. These examples are not to be construed as limiting the scope of the invention as these and other equivalent embodiments will be apparent in view of the present disclosure, figures, and accompanying claims.

### EXAMPLES

The following examples are specific embodiments of the present disclosure but are not intended to limit it.

### Example 1

### Transesterification of Triacylglycerides

All transesterification reactions were performed with analytical grade reagents (Sigma Aldrich) and were used without further purification. Microwave reactions were performed in a Biotage Initiator microwave reactor using 0.2-0.5 mL and 0.5-2.0 mL microwave reaction vials equipped with magnetic stirring bars and Reseal™ septa. GC-MS analysis was performed on a Hewlett Packard 5971A GC-MS system using an HP5-MS column. Splitless injections of 1 μL were made using an initial temperature of 60° C., holding 2 min, then 20° C./min ramp to 280° C., and holding 2 min. Helium was used as the carrier gas. To determine yield, reaction mixtures were diluted to the midpoint of the calibration curve with a known solution of methyl stearate (assuming quantitative conversion to product). The TIC area ratios (TIC sample/TIC internal standard) were compared to the respective TIC area ratios of the standard curves.^{15,16} Five-point linear calibration curves were prepared in triplicate for each methyl ester analyte using methyl stearate as an internal standard. The R² values of the curves were between 0.98-0.99 for each methyl ester and used to calculate percent error in the midpoint. The error for methyl oleate, methyl linoleate, methyl myristate, and methyl palmitate midpoints (509 μM) were 3.9%, 3.6%, 8.7%, 5.3%, respectively.

All reactions were performed in duplicate and analyzed in triplicate, and the tabulated percent yields represent an average of the six data points obtained from each reaction. Selected non-quantitative transesterifications were analyzed by thin-layer chromatography (TLC) on EMD silica gel 60 F254 plates using a 1:1 hexanes:dichloromethane solvent system to assess the presence of acylglycerol starting materials.

All transesterifications used 35 μmol of the triacylglycerol and 10 mol % of either Sc(OTf)₃ or Bi(OTf)₃. The reactions were carried out in the microwave reactor with either 6, 12, or 48 equivalents of methanol per ester of the triacylglycerol for the indicated period of time. Results are presented in Table 1 below. The reactions were analyzed as described above. Analytical TLC of non-quantitative reactions revealed only the presence of triacylglycerol starting materials; no mono- or di-acylglycerols were detected.

TABLE 1
Scandium and bismuth triflate-catalyzed transesterification

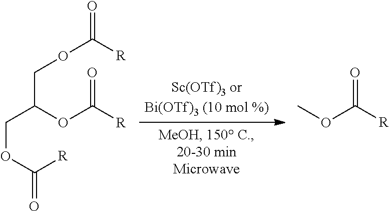

| | | MeOH | | Temp. | |
|---|---|---|---|---|---|
| TAG | Catalyst | eq. | Time (min) | (° C.) | Percent Yield |
| oleate | Sc(OTf)₃ | 6 | 20 | 150 | 18 |
| oleate | Sc(OTf)₃ | 12 | 20 | 150 | 31 |
| oleate | Sc(OTf)₃ | 48 | 20 | 150 | 92 |
| oleate | Bi(OTf)₃ | 48 | 25 | 150 | 85 |
| linoleate | Sc(OTf)₃ | 48 | 20 | 150 | 90 |
| linoleate | Bi(OTf)₃ | 48 | 25 | 150 | 84 |
| myristate | Sc(OTf)₃ | 48 | 30 | 150 | 82 |
| myristate | Bi(OTf)₃ | 48 | 25 | 150 | 99 |
| palmitate | Sc(OTf)₃ | 48 | 20 | 150 | 99 |
| palmitate | Bi(OTf)₃ | 48 | 25 | 150 | 92 |

Catalytic quantities of scandium triflate promoted efficient methanolysis of the triacylglycerols in a microwave reactor. Optimization of catalyst loading, reaction time, and the methanol stoichiometry revealed the following exemplary reaction conditions for transesterification: 10 mol % scandium triflate, 20 minutes at 150° C., and a 48:1 ratio of methanol to ester of the triacylglycerol. The reaction yields were determined by gas chromatography-mass spectrometry (GC-MS) according to standard procedures.^{15,16} Methanolysis of glyceryl trioleate using catalytic scandium triflate occurred in 18%, 31%, and 92% yield with methanol:ester ratios of 6:1, 12:1, and 48:1, respectively (Table 1). Under similar conditions, bismuth triflate was nearly as effective as scandium triflate in these reactions.

### Example 2

### Esterification of Free Fatty Acids

All esterification reactions were performed with analytical grade reagents (Sigma Aldrich) and were used without further purification. Microwave reactions were performed in a Biotage Initiator microwave reactor using 0.2-0.5 mL and 0.5-2.0 mL microwave reaction vials equipped with magnetic stirring bars and Reseal™ septa. GC-MS analysis was performed on a Hewlett Packard 5971A GC-MS system using an HP5-MS column. Splitless injections of 1 μL were made using an initial temperature of 60° C., holding 2 min, then 20° C./min ramp to 280° C., and holding 2 min. Helium was used as the carrier gas. To determine yield, reaction mixtures were diluted to the midpoint of the calibration curve with a known solution of methyl stearate (assuming quantitative conversion to product). The TIC area ratios (TIC sample/TIC internal standard) were compared to the respective TIC area ratios of the standard curves.^{15,16} Five-point linear calibration curves were prepared in triplicate for each methyl ester analyte using methyl stearate as an internal standard. The R² values of the curves were between 0.98-0.99 for each methyl ester and used to calculate percent error in the midpoint (see supporting data). The error for methyl oleate, methyl linoleate, methyl myristate, and methyl palmitate midpoints (509 μM) were 3.9%, 3.6%, 8.7%, 5.3%, respectively.

All reactions were performed in duplicate and analyzed in triplicate, and the tabulated percent yields represent an average of the six data points obtained from each reaction.

All esterification reactions used 100 μmol of the fatty acid and 1 mol % of either Sc(OTf)₃ or Bi(OTf)₃. The reactions were carried out in the microwave reactor with either 12, 24, or 48 equivalents of methanol per fatty acid for the indicated period of time. Upon completion, the reactions were analyzed as described in the general methods section. Results are presented in Table 2 below.

TABLE 2
Scandium and bismuth triflate catalyzed conversion of free fatty
acids (FFA) to methyl esters

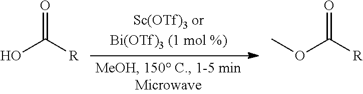

| | | MeOH | | Temp. | |
|---|---|---|---|---|---|
| FFA | Catalyst | eq. | Time (min) | (° C.) | Percent Yield |
| linoleic | Sc(OTf)₃ | 48 | 1 | 50 | 24 |
| linoleic | Sc(OTf)₃ | 48 | 1 | 100 | 55 |
| linoleic | Sc(OTf)₃ | 48 | 5 | 50 | 30 |
| linoleic | Sc(OTf)₃ | 48 | 5 | 100 | 81 |
| linoleic | Sc(OTf)₃ | 48 | 1 | 150 | 97 |
| linoleic | Bi(OTf)₃ | 48 | 1 | 150 | 98 |
| linoleic | Sc(OTf)₃ | 12 | 1 | 150 | 55 |
| linoleic | Sc(OTf)₃ | 24 | 1 | 150 | 75 |
| oleic | Sc(OTf)₃ | 48 | 1 | 150 | 100 |
| oleic | Bi(OTf)₃ | 48 | 1 | 150 | 88 |
| myristic | Sc(OTf)₃ | 48 | 1 | 150 | 98 |
| myristic | Bi(OTf)₃ | 48 | 1 | 150 | 90 |
| palmitic | Sc(OTf)₃ | 48 | 1 | 150 | 100 |
| palmitic | Bi(OTf)₃ | 48 | 1 | 150 | 99 |

In a microwave reactor, both scandium triflate and bismuth triflate catalyzed the conversion of fatty acids to methyl esters. Exemplary reaction conditions for esterification were a reaction time of 1 minute using 1 mol % of either metal catalyst at 150° C. with a 48-fold molar excess of methanol. The reaction temperature, reaction time, and the methanol stoichiometry were all found to influence percent yield. As an example of the temperature-dependence, glyceryl trilineoleate was esterified (1 mol % Sc(OTf)₃, 48 eq. of MeOH, 1 minute reaction time) in 24% yield at 50° C., 81% yield at 100° C., and 97% yield at 150° C. Extension of the reaction time from one minute to five minutes did not result in high yielding esterifications at either 50° C. or 100° C. The methanol stoichiometry of the reactions also influenced yield as the yield dropped from 97% to 55% when the amount of the methanol was reduced from 48 eq. to 12 eq., respectively.

### Example 3

### Reaction Mixtures of Triacyglycerides and Free Fatty Acids

Reactions were carried out in one reaction vessel converting a mixture of triacylglycerols and free fatty acids into their respective methyl esters. In a single reaction vessel, 35 μmol of triolein and 85 μmol of palmitic acid were dissolved in 205 μL of MeOH with 10 mol % (3.5 μmol) of either Sc(OTf)₃ or Bi(OTf)₃. The reactions were heated to 150° C. for 20 min in the microwave reactor. Upon completion, the reactions were analyzed as described above with respect to Example 1.

10 mol % of either scandium triflate or bismuth triflate catalyzed the conversion of a 1:1 mixture of palmitic acid and glyceryl trioleate to methyl oleate and methyl palmitate in 20 minutes at 150° C. according to the general reaction scheme below.

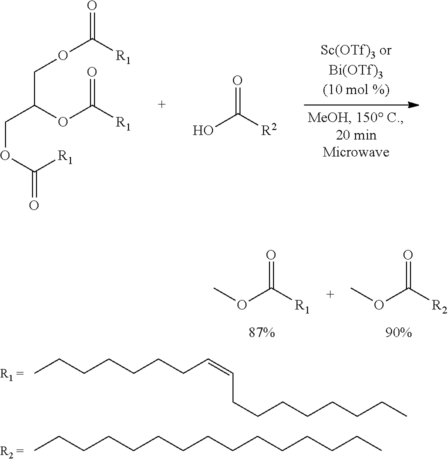

### Example 4

### Catalyst Recovery

A series of experiments were carried out to assess the recyclability of scandium triflate and bismuth triflate in esterification reactions. The catalyst recycling experiments for esterification reactions of palmitic acid were executed based on observations that catalyst recovery at each recycling step was approximately 80%. Thus, the initial esterification was carried out in the microwave reactor (1 min, 150° C.) with 100 mg (0.39 mmol) of palmitic acid in 800 μL of MeOH with 10 mol % of catalyst. Upon completion, the reaction was analyzed as described above. The dichloromethane-diluted reaction mixture was subjected to aqueous workup to separate the catalyst from the methyl ester product. The aqueous phase was lypholized to recover the catalyst as a white powder. Five subsequent reactions were performed as described using 10 mol % of recovered catalyst. In the sixth and final recycled reaction, only 1 mol % of the recovered catalyst was used to ensure that it was fully active.

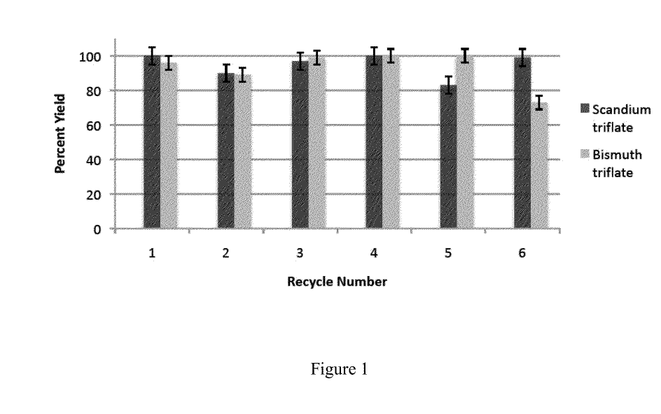

Both metal catalysts could be recycled at least six times for use in the esterification of palmitic acid. FIG. 1 shows the yields of palmitic acid esterification from sequential catalyst recycling experiments. Error bars indicate average standard deviation. The recovered scandium triflate did not lose any catalytic activity insofar as a reaction using 1 mol % of catalyst that was recycled five times gave a 97% yield in an esterification of palmitic acid.

### Example 5

### Comparative Example Using a Lewis Acid Catalyst in Refluxing Methanol

An experiment was conducted purposes of determining the investigated the utility of scandium triflate for the catalytic conversion of triacylglycerols commonly found in virgin plant oils (glyceryl trioleate, glyceryl trilinoleate, glyceryl trimyristate, and glyceryl tripalmitate) into fatty acid methyl esters in refluxing methanol at 60° C. Interestingly, we found that under these conditions neither catalytic nor stoichiometric quantities of scandium triflate appreciably catalyzed the desired reaction. As was the case for the transesterification reactions, the metal catalysts did not catalyze the reaction of free fatty acids into fatty acid methyl esters in refluxing methanol. In these reactions, the metal catalyst of choice was added to a solution of the triacylglycerols in methanol. The solution was subsequently heated to 60° C. in a flask coupled to a reflux condenser. After more than 12 hours, no product formation was observed.

### Example 6

### Conversion of Triacylglycerols to Free Fatty Acids

Methods of hydrolysis are known. See U.S. Pat. No. 4,218,386 hereby incorporated herein by reference in its entirety. An experiment was conducted to convert triacylglycerols to free fatty acids using microwave heating. Catalytic amounts of strong mineral acids such as sulfuric acid, hydrochloric acid and triflic acid is mixed with triacylglycerols dissolved in water and acetic acid and heated in a microwave to 150° C. for between about 1 minute to about 20 minutes to produce free fatty acids in approximately 90% yield. In particular, 12 ml of acetic acid, 2.5 ml of water, 200 μl of sulfuric acid and 5 ml of recycled cooking oil is combined and heated in a microwave for 2.5 minutes at 200° C. in a sealed, 20 ml reaction vial. Upon cooling, the top layer is analyzed by thin layer chromatography using petroleum ether:ethylacetate:acetic acid (80:20:1) as a mobile phase. The spots can be visualized by heating with seric ammonium molybdenate stain. The Rf of the triacylglycerol starting material is about 0.8. The Rf of the fatty acid products is about 0.45.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. While the invention has been illustrated and described in detail in the drawings and foregoing description, such illustration and description is to be considered as exemplary and not restrictive in character, it being understood that, only the preferred embodiments have been shown and described and that all changes and modifications that come within the spirit of the invention are desired to be protected. The appended claims are intended to cover all such modifications and alternative embodiments. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc. References identified herein are expressly incorporated herein by reference in their entireties unless otherwise indicated.

What is claimed is:

1. A method of making alkyl esters comprising combining a Lewis acid in a catalytically effective amount, an alcohol and one or more compounds of formula 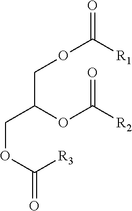
wherein R₁, R₂, or R₃ is an alkyl chain having between about 3 carbon atoms and about 27 carbon atoms, wherein the alkyl chain is a straight chain or a branched chain and wherein the alkyl chain is saturated or unsaturated and wherein the alkyl chain is substituted or unsubstituted; and
heating the combination using microwaves to produce alkyl esters by transesterification of the one or more compounds of the formula.

2. A method of making alkyl esters comprising combining a Lewis acid in a catalytically effective amount, an alkanol and one or more compounds of formula 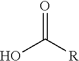
wherein R is an alkyl chain having between about 3 carbon atoms and about 27 carbon atoms, wherein the alkyl chain is a straight chain or a branched chain and wherein the alkyl chain is saturated or unsaturated and wherein the alkyl chain is substituted or unsubstituted; and
heating the combination using microwaves to produce alkyl esters by esterification of the one or more compounds of the formula.

3. A method of making alkyl esters comprising combining a Lewis acid in a catalytically effective amount, an alkanol, one or more compounds of formula I 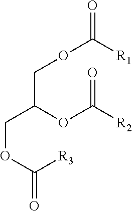
wherein R₁, R₂, or R₃ is an alkyl chain having between about 3 carbon atoms and about 27 carbon atoms, wherein the alkyl chain is a straight chain or a branched chain and wherein the alkyl chain is saturated or unsaturated and wherein the alkyl chain is substituted or unsubstituted, and one or more compounds of formula II 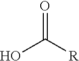
wherein R is an alkyl chain having between about 3 carbon atoms and about 27 carbon atoms, wherein the alkyl chain is a straight chain or a branched chain and wherein the alkyl chain is saturated or unsaturated and wherein the alkyl chain is substituted or unsubstituted; and
heating the combination using microwaves to produce alkyl esters by transesterification of the one or more compounds of the formula I and to produce alkyl esters by esterification of the one or more compounds of the formula II.

4. A method of making biodiesel comprising combining a Lewis acid in a catalytically effective amount, an alkanol, one or more compounds of formula I 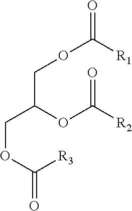
wherein R₁, R₂, or R₃ is an alkyl chain having between about 3 carbon atoms and about 27 carbon atoms, wherein the alkyl chain is a straight chain or a branched chain and wherein the alkyl chain is saturated or unsaturated and wherein the alkyl chain is substituted or unsubstituted, and one or more compounds of formula II 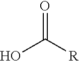
wherein R is an alkyl chain having between about 3 carbon atoms and about 27 carbon atoms, wherein the alkyl chain is a straight chain or a branched chain and wherein the alkyl chain is saturated or unsaturated and wherein the alkyl chain is substituted or unsubstituted; and
heating the combination using microwaves to produce alkyl esters by transesterification of the one or more compounds of the formula I and to produce alkyl esters by esterification of the one or more compounds of the formula II.

5. A method of making biodiesel comprising combining a Lewis acid in a catalytically effective amount, an alkanol, and vegetable oil including glycerides and free fatty acids, and
heating the combination using microwaves to produce alkyl esters from the glycerides and the free fatty acids.

6. A method of making free fatty acids comprising combining a strong acid catalyst in a catalytically effective amount, water and one or more compounds of formula 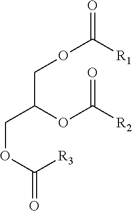
wherein R₁, R₂, or R₃ is an alkyl chain having between about 3 carbon atoms and about 27 carbon atoms, wherein the alkyl chain is a straight chain or a branched chain and wherein the alkyl chain is saturated or unsaturated and wherein the alkyl chain is substituted or unsubstituted; and
heating the combination using microwaves to produce free fatty acids by hydrolysis of the one or more compounds of the formula.
